(19) United States
(12) Patent Application Publication
(10) Pub. No.: US 2001/0043881 A1
(43) Pub. Date: Nov. 22, 2001

(54) Process for gas adsorption using aminomethylated bead polymers

(76) Inventors: Rudolf Wagner, Koln (DE); Ulrich Schnegg, Leverkusen (DE); Wolfgang Wambach, Koln (DE); Reinhold Klipper, Koln (DE)

Correspondence Address: BAYER CORPORATION, PATENT DEPARTMENT, 100 BAYER ROAD, PITTSBURGH, PA, 15205, US

(21) Appl. No.: 09/851,726

(22) Filed: May 9, 2001

(30) Foreign Application Priority Data
May 16, 2000 (DE) 10023970.6

(51) Int. Cl. A62B 18/02; A62B 7/10

(52) U.S. Cl. 422/4; 422/122

(57) ABSTRACT

The present invention relates to a process for gas adsorption, in particular of acidic gases, using monodisperse aminomethylated bead polymers.

### BACKGROUND OF THE INVENTION

The present invention relates to a process for gas adsorption, in particular of acidic gases, using monodisperse aminomethylated bead polymers.

Aminomethylated bead polymers according to the present invention are understood to be bead polymers which are produced by the phthalimide process or the chloromethylation process. In the chloromethylation process the intermediately produced chloromethylate is reacted with urotropine and then with an acid to form an aminomethylated bead polymer.

In the present application monodisperse substances are understood to be those in which at least 90% by volume or weight of the particles have a diameter within a range of 10% above or below the predominant diameter. For example, in the case of a bead polymer whose beads have a predominant diameter of 0.50 mm, at least 90% by volume or weight have a size between 0.45 mm and 0.55 mm, or in the case of a bead polymer whose beads have a predominant diameter of 0.70 mm at least 90% by volume or weight have a size between 0.77 mm and 0.63 mm. The present invention relates to the use of those bead polymers whose monodisperse property is based on the production process and are thus obtainable by jetting, seed/feed or direct atomization. Those processes are described for example in U.S. Pat. Nos. 3,922,255, 4,444,961 and 4,427,794.

DE 19 830 470 C1 discloses a regenerative process for CO₂ adsorption in which a macroporous ion-exchange resin is exposed to a medium comprising CO₂. This ion exchange resin is composed of vinylbenzene polymers crosslinked with divinylbenzene and contains primary benzylamines as functional groups.

The ion exchangers to be used, according to the prior art, are prepared according to German Offenlegungsschrift 2 519 244. A disadvantage of the process according to DE 19 830 470 C1 is the fact that the ion exchangers are heterodispersed and due to their morphology have different bead sizes and relatively low porosity, with mostly small pore diameters.

An object was therefore to develop new ion exchangers for gas adsorption that do not have the above-mentioned disadvantages of the prior art and are therefore more universal in their application.

DE-A 19 940 864 discloses a process for preparing monodisperse anion exchangers by

(a) reacting monomer droplets made from at least one monovinylaromatic compound and at least one polyvinylaromatic compound, and, if desired, a porogen and/or, if desired, an initiator or an initiator combination to give a monodisperse, crosslinked bead polymer,

(b) amidomethylating the resultant monodisperse, crosslinked bead polymer using phthalimide derivatives,

(c) reacting the amidomethylated bead polymer to give an aminomethylated bead polymer, and

(d) alkylating the aminomethylated bead polymer.

It has now been found that the aminomethylated products from process step (c) have surprisingly good suitability for gas adsorption.

### SUMMARY OF THE INVENTION

The present invention therefore provides a process for the adsorption of gases comprising adsorbing the gases in open, closed, or partially closed systems or spaces with monodisperse aminomethylated bead polymers based on at least one monovinylaromatic compound and at least one polyvinylaromatic compound and having a porosity of from 40 to 70%, wherein the bead polymers are prepared by a process comprising

(a) reacting monomer droplets made from at least one monovinyl-aromatic compound and at least one polyvinylaromatic compound, and, if desired, a porogen and/or, if desired, an initiator or an initiator combination to give a monodisperse, crosslinked bead polymer,

(b) amidomethylating the monodisperse, crosslinked bead polymer using phthalimide derivatives, and

(c) converting the amidomethylated bead polymer to an amino-methylated bead polymer.

### DETAILED DESCRIPTION OF THE INVENTION

In process step (a) of DE-A 19 940 864 at least one monovinyl-aromatic compound and at least one polyvinylaromatic compound are used. However, it is also possible to use mixtures of two or more mono-vinylaromatic compounds and mixtures of two or more polyvinylaromatic compounds.

The monovinylaromatic compounds used in process step (a) are according to DE-A 19 940 864 preferably monoethylenically unsaturated compounds, such as styrene, vinyltoluene, ethylstyrene, α-methylstyrene, chlorostyrene, chloromethylstyrene, alkyl acrylates, or alkyl methacrylates. Styrene, or a mixture made from styrene with the above-mentioned monomers, is particularly preferably used.

In process step (a) preferred polyvinylaromatic compounds according to DE-A 19 940 864 are polyfunctional ethylenically unsaturated compounds, such as divinylbenzene, divinyltoluene, trivinylbenzene, divinylnaphtaline, trivinylnaphtaline, 1,7-octadiene, 1,5-hexadiene, ethylene glycol dimethacrylate, trimethylolpropane trimethacrylate, or allyl methacrylate.

The amounts of the polyvinylaromatic compounds used are generally from 1-20% by weight (preferably from 2-12% by weight, particularly preferably from 4-10% by weight), based on the monomer or its mixture with other monomers. The nature of the polyvinylaromatic compounds (crosslinkers) is selected with regard to the subsequent use of the spherical polymer as gas absorber. In many cases divinylbenzene is suitable. For most applications it is sufficient to use commercial quality divinylbenzene,this comprising ethylvinylbenzene as well as the isomers of divinylbenzene.

The amount in % by weight of polyvinylaromatic compounds in the monomer mixture is given as the degree of crosslinking.

In one preferred embodiment, microencapsulated monomer droplets are used in process step (a) of DE-A 19 940 864.

The materials that can be used for microencapsulating the monomer droplets are those known for use as complex coacervates, in particular polyesters, naturally occurring or synthetic polyamides, polyurethanes, and polyureas.

An example of a particularly suitable natural polyamide is gelatin. This is used in particular as coacervate and complex coacervate. According to DE-A 19 940 864, gelatin-containing complex coacervates are primarily combinations of gelatin with synthetic polyelectrolytes. Suitable synthetic polyelectrolytes are copolymers incorporating units of, for example, maleic acid, acrylic acid, methacrylic acid, acrylamide, or methacrylamide. Particular preference is given to the use of acrylic acid and acrylamide. Gelatin-containing capsules may be hardened using conventional hardeners, such as formaldehyde or glutaric dialdehyde. The encapsulation of monomer droplets with gelatin, with gelatin-containing coacervates, and with gelatin-containing complex coacervates is described in derail in EP-A 46 535. The methods for Encapsulation using synthetic polymers are known. An example of a highly suitable process is interfacial condensation, in which a reactive component dissolved in the monomer droplet (for example an isocyanate or an acid chloride) is reacted with a second reactive component (for example an amine) dissolved in the aqueous phase.

The monomer droplets, which can be microencapsulated if desired, may, if desired, comprise an initiator or mixtures of initiators to initiate the polymerization. Examples of initiators suitable for the novel process are peroxy compounds, such as dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane, and tert-amylperoxy-2-etylhexane, and also azo compounds, such as 2,2′-azobis(isobutyronitrile) and 2,2′-azobis(2-methylisobutyronitrile).

The amounts of the initiators used are generally from 0.05 to 2.5% by weight (preferably from 0.1 to 1.5% by weight), based on the mixture of monomers.

To create a macroporous structure in the spherical polymer it is possible, if desired, to use porogens as other additives in the optionally microencapsulated monomer droplets. Suitable compounds for this purpose are organic solvents that are poor solvents and/or swelling agents with respect to the polymer produced. Examples that may be mentioned are hexane, octane, isooctane, isododecane, methyl ethyl ketone, butanol, and octanol and isomers thereof.

The terms microporous, gel, and macroporous have been described in detail in the technical literature.

Bead polymers preferred for DE-A 19 940 864, prepared by process step (a), have a macroporous structure.

One way of forming monodisperse, macroporous bead polymers is to add inert materials (porogens) to the monomer mixture during the polymerization. Suitable substances are especially organic substances that dissolve in the monomer but are poor solvents or swelling agents for the polymer (precipitants for polymers), such as aliphatic hydrocarbons. For example, alcohols having from 4 to 10 carbon atoms may be used as porogen for preparing monodisperse macroporous bead polymers based on styrene/divinylbenzene. DE-A 19 940 864 lists numerous literature references in this connection.

The monomer droplets, which can be microencapsulated where appropriate, comprise up to 30% by weight (based on the monomer) of crosslinked or non-crosslinked polymer. Preferred polymers derive from the above-mentioned monomers, particularly preferably from styrene.

The average particle size of the monomer droplets, that can be encapsulated if desired, is from 10 to 4000 μm, preferably from 100 to 1000 μm. The process according to DE-A 19 940 864 is thus very suitable for preparing monodisperse spherical polymers used for gas adsorption in the present invention.

When monodisperse bead polymers are prepared according to process step (a) of DE 19 940 864 the aqueous phase may, if desired, comprise a dissolved polymerization inhibitor. Both inorganic and organic substances are possible inhibitors for the purposes of the present invention. Examples of inorganic inhibitors are nitrogen compounds, such as hydroxylamine, hydrazine, sodium nitrite, and potassium nitrite, salts of phosphorous acid, such as sodium hydrogenphosphite, and sulfur-containing compounds, such as sodium dithionite, sodium thiosulfate, sodium sulfite, sodium bisulfite, sodium thiocyanate, and ammonium thiocyanate. Examples of organic inhibitors are phenolic compounds, such as hydroquinone, hydroquinone monomethyl ether, resorcinol, pyro-catechol, tert-butylpyrocatechol, pyrogallol, and condensation products made from phenols with aldehydes. Other suitable organic inhibitors are nitrogen-containing compounds, including hydroxylamine derivatives, such as N,N-diethylhydroxylamine, N-isopropylhydroxylamine, and sulfonated or carboxylated derivatives of N-alkylhydroxylamine or of N,N-dialkylhydroxy-lamine, hydrazine derivatives, such as N,N-hydrazinodiacetic acid, nitroso compounds, such as N-nitrosophenylhydroxylamine, the ammonium salt of N-nitrosophenylhydroxylamine, or the aluminium salt of N-nitrosophenyl-hydroxylamine. The concentration of the inhibitor is from to 5 to 1000 ppm (preferably from 10 to 500 ppm, particularly preferably from 10 to 250 ppm), based on the aqueous phase.

As mentioned above, the polymerization of the monomer droplets, which can be microencapsulated if desired, to give the spherical mono-disperse bead polymer may, if desired, take place in the presence of one or more protective colloids in the aqueous phase. Protective colloids are natural or synthetic water-soluble polymers, such as gelatin, starch, polyvinyl alcohol, polyvinylpyrrolidone, polyacrylic acid, polymethacrylic acid, or copolymers made from (meth)acrylic acid and from (meth)-acrylates. Other very suitable materials are cellulose derivatives, in particular cellulose esters and cellulose ethers, such as carboxymethyl-cellulose, methylhydroxyethylcellulose, methylhydroxypropylcellulose, and hydroxyethylcellulose. Gelatin is particularly suitable. The amount of the protective colloids used is generally from 0.05 to 1% by weight (preferably from 0.05 to 0.5% by weight), based on the aqueous phase.

The polymerization to give the spherical, monodisperse bead polymer according to DE-A 19 940 864 may, where appropriate, also be carried out in the presence of a buffer system in process step (a). Preference is given to buffer systems that set the pH of the aqueous phase at the beginning of the polymerization to between 14 and 6, preferably between 12 and 8. Under these conditions protective colloids having carboxylic acid groups are present to some extent or entirely in the form of salts. This has a favorable effect on the action of the protective colloids. Buffer systems that are particularly suitable comprise phosphate salts or borate salts. For the purposes of the present invention, the terms phosphate and borate include the condensation products of the ortho forms of the corresponding acids and salts. The concentration of phosphate or borate in the aqueous phase is from 0.5 to 500 mmol/l, preferably from 2.5 to 100 mmol/l.

The stirring speed during the polymerization is relatively non-critical and, unlike in conventional bead polymerization, has no effect on the particle size. The stirring speeds used are low speeds that are sufficient to keep the monomer droplets in suspension and to promote dissipation of the heat of polymerization. A variety of stirrer types can be used for this task. Gate stirrers with an axial action are particularly suitable.

The ratio by volume of encapsulated monomer droplets to aqueous phase is from 1:0.75 to 1:20, preferably from 1:1 to 1:6.

The polymerization temperature depends on the decomposition temperature of the initiator used and is generally from 50 to 180° C., preferably from 55 to 130° C. The polymerization takes from 0.5 hour to a few hours. It has proven successful to use a temperature programme in which the polymerization is begun at a low temperature, for example, 60° C., and the reaction temperature is raised as the polymerization conversion progresses. This is a very good way of fulfilling, for example, the requirement for a reaction which proceeds reliably and with a high polymerization conversion. In one preferred embodiment, the polymerization may be carried out in a process-controlled system. After the polymerization the polymer is isolated by conventional methods, for example, by filtration or decanting, and, where appropriate, washed.

In process step (b) according to DE-A 19 940 864 the amido-methylating reagent is first prepared. This is done, for example, by dissolving a phthalimide or a phthalimide derivative in a solvent and mixing with formalin. A bis(phthalimido) ether is then formed from this material with elimination of water. Preferred phthalimide derivatives in DE-A 19 940 864 are phthalimide itself and substituted phthalimides, such as methylphthalimide.

In process step (b) according to DE-A 19 940 864 the solvents used are inert solvents suitable for swelling the polymer, preferably chlorinated hydrocarbons, particularly preferably dichloroethane or methylene chloride.

In process step (b) according to DE-A 19 940 864 the bead polymer is condensed with phthalimide derivatives. The catalyst used comprises oleum, sulfuric acid, or sulfur trioxide.

Process step (b) according to DE-A 19 940 864 is carried out at temperatures of from 20 to 120° C., preferably from 50 to 100° C., particularly preferably from 60 to 90° C.

The cleavage of the phthalic acid moiety and therefore the liberation of the aminomethyl group takes place in DE-A 19 940 864 in process step (c) by treating the phthalimidomethylated crosslinked bead polymer with aqueous or alcohol solutions of an alkali metal hydroxide, such as sodium hydroxide or potassium hydroxide, at temperatures of from 100 to 250° C., preferably from 120 to 190° C. The concentration of the sodium hydroxide solution is within the range from 10 to 50% by weight, preferably from 20 to 40% by weight. This method permits the preparation of crosslinked bead polymers containing aminoalkyl groups and having a degree of substitution of more than 1 on the aromatic rings.

Preferred parameters for the monodisperse aminomethylated bead polymers according to process step (c) of DE-A 19 940 864 in the use as gas adsorbents are:

a high degree of crosslinking, from 2 to 90% (preferably from 2 to 60%, particularly preferably from 2 to 20%),

a porosity of the monodisperse aminomethylated bead polymers that lies between 40 and 60% (particularly preferably between 45 and 55%),

a concentration of the functional groups of from 0.2 to 3.0 mol/l (preferably from 1.5 to 2.5 mol/l) of bead polymer, and

an average pore diameter of from 100 to 900 Angstrom (preferably from 300 to 550 Angstrom).

In one advantageous embodiment, the monodisperse, aminomethylated bead polymer is exposed to the gas or gas mixture to be absorbed (i.e., to the air available for breathing) in open, closed, or partially closed spaces, by passing the air, by means of an air-supply device or as a result of inhalation, through a bed of bead polymer. On flowing through the bed, the gas molecules become bonded to the functional amino groups on the external and internal surfaces of the monodisperse macroporous resin beads (diameter typically in the range from 400 to 600 μ), with consequent impoverishment of the transient medium.

There are various ways of regenerating the monodisperse aminomethylated bead polymer after saturation with acidic gases. The selection of the type of regeneration depends on the application under consideration and on other technical and logistical parameters:

Regeneration of the monodisperse aminomethylated bead polymer after saturation with acidic gases by applying steam and thus driving off the adsorbed gas.

Regeneration of the monodisperse aminomethylated bead polymer after saturation with acidic gases by applying a subatmospheric pressure with or without additional application of heat (e.g., in the form of steam) and/or applying hot gases, for example, nitrogen, air, or inert gases, such as helium or argon, and thus driving off the adsorbed gas.

Regeneration of the monodisperse aminomethylated bead polymer after saturation with acidic gases by applying heated or unheated CO₂-free air and thus driving off the adsorbed gas.

Preferred application sectors are the adsorption of gases in survival systems for spacecraft, buildings, plants or vehicles, for example, in submarines, air-conditioning in aircraft, in mines, or in chemical factories, or else respiratory devices and survival systems in the medical sector or in diving equipment.

For the purposes of the present invention, other application sectors are the adsorption of chemical gases in respiratory protection masks for use in areas where appropriate gases can occur, for example in chemical factories.

The present invention also provides respiratory protection masks, protective clothing, and survival systems that have been equipped with a sufficient amount of a bed made from monodisperse aminomethylated bead polymers, in order to remove acidic gases or organic gases or vapors, such as formaldehyde, over prolonged periods by adsorption.

For the purposes of the present invention, particular gases to be adsorbed are acidic gases, such as carbon monoxide (CO), carbon dioxide (CO₂) from natural or metabolic sources, nitrous gases, such as NO, NO₂, N₂O, or N₂O₅, sulfur oxides, such as SO₂ or SO₃, gaseous hydrogen halides, such as HCl or HBr, and also H₂S, dicyan, phosgene, or organic gases, such as formaldehyde or organic vapors from e.g. alcohols, ketones halogenated carbonhydrates etc. for example such as methanole, acetone etc.

### EXAMPLES

### Example 1

a) Preparation of a monodisperse macroporous bead polymer based on styrene, divinylbenzene, and ethylstyrene 3000 g of deionized water were placed in a 10 liter glass reactor, and a solution made from 10 g of gelatin, 16 g of disodium hydrogen phosphate dodecahydrate, and 0.73 g of resorcinol in 320 g of deionized water was added and thoroughly mixed. The temperature of the mixture was controlled at 25° C. Then, with stirring, a mixture made from 3200 g of microencapsulated monomer droplets with a narrow particle size distribution and made from 3.6% by weight of divinylbenzene and 0.9% by weight of ethylstyrene (used in the form of a commercially available isomer mixture of divinylbenzene and ethylstyrene with 80% of divinylbenzene), 0.5% by weight of dibenzoyl peroxide, 56.2% by weight of styrene, and 38.8% by weight of isododecane (industrial isomer mixture with a high proportion of pentamethylheptane) was introduced, the microcapsule being composed of a formaldehyde-hardened complex coacervate made from gelatin and from a copolymer of acrylamide and acrylic acid, and 3200 g of aqueous phase with a pH of 12 were added. The average particle size of the monomer droplets was 460 μm.

The mix was polymerized to completion, with stirring, by increasing the temperature according to a temperature program starting at 25° C. and finishing at 95° C. The mix was cooled, washed using a 32 μm screen, and then dried in vacuo at 80° C. This gave 1893 g of a spherical polymer with an average particle size of 440 μm, narrow particle size distribution, and a smooth surface.

The polymer had a chalky white appearance from above and had a bulk density of about 370 g/l.

1b) Preparation of an amidomethylated bead polymer 2400 ml of dichloroethane, 595 g of phthalimide, and 413 g of 30.0% strength by weight formalin were placed in a vessel at room temperature. The pH of the suspension was set to 5.5 to 6 using sodium hydroxide solution. The water was then removed by distillation. 43.6 g of sulfuric acid were then metered in, the resultant water was removed by distillation, and the mix was cooled. 174.4 g of 65% strength oleum were metered in at 30° C., followed by 300.0 g of monodisperse bead polymer prepared according to process step 1a). The suspension was heated to 70° C. and stirred for a further 6 hours at this temperature. The reaction liquid was drawn off, deionized water was metered in, and residual dichloroethane was removed by distillation.

Yield of amidomethylated bead polymer: 1820 ml

Composition by elemental analysis: carbon: 75.3% by weight; hydrogen: 4.6% by weight; nitrogen: 5.75% by weight.

1c) Preparation of the aminomethylated bead polymer 851 g of 50% strength by weight sodium hydroxide solution and 1470 ml of deionized water were metered at room temperature into 1770 ml of amidomethylated bead polymer from Example 1b). The suspension was heated to 180° C. and stirred for 8 hours at this temperature.

The resultant bead polymer was washed with deionized water.

Yield of aminomethylated bead polymer: 1530 ml

The overall yield—extrapolated—was 1573 ml.

Composition by elemental analysis: carbon: 78.2% by weight; nitrogen: 12.25% by weight; hydrogen: 8.4% by weight.

Amount of aminomethyl groups in mol per litre of aminomethylated bead polymer: 2.13

Amount of aminomethyl groups in mol in the overall yield of amino-methylated bead polymer: 3.259

On statistical average per aromatic ring—stemming from styrene and divinylbenzene units—1.3 hydrogen atoms had been substituted by aminomethyl groups.

### Porosity as a Measure for Gas Adsorption

To determine the porosity of a macroporous bead polymer, mercury porosimetry was used to determine the pore distribution and the pore volume of the macroporous bead polymers. The total volume of the bead polymers is equal to the total pore volume plus the solids volume. The porosity in % is equal to the quotient calculated by dividing the total pore volume by the total volume of the bead polymer.

### Comparative Example

In comparison with the prior art (see DE 19 830 470 C1) and due to their higher porosity, the monodisperse aminomethylated products from process step c) exhibited a markedly higher adsorption rate for acidic gases, such as carbon monoxide (CO), carbon dioxide (CO₂) from natural or metabolic sources, nitrous gases, sulfur oxides, gaseous hydrogen halides, dicyan, or phosgene and also for organic gases and vapors, such as formaldehyde. The monodisperse products from the process exhibited porosities in the range from 40 to 60%, while the bead polymers prepared according to the prior art and used in DE 19 830 470 C1 exhibited porosities of from 20 to 30%. Surprisingly, it has been found that the level of absorption of acidic gases or organic gases or vapors by the bead polymer rises with increasing porosity.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the adsorption of gases comprising adsorbing the gases in an open, closed, or partially closed system or space with a monodisperse aminomethylated bead polymer based on at least one monovinylaromatic compound and at least one polyvinylaromatic compound and having a porosity of from 40 to 70%, wherein the bead polymers are prepared by a process comprising
(a) reacting monomer droplets made from at least one monovinyl-aromatic compound and at least one polyvinylaromatic compound, and, if desired, a porogen and/or, if desired, an initiator or an initiator combination to give a monodisperse, crosslinked bead polymer,
(b) amidomethylating the monodisperse, crosslinked bead polymer using phthalimide derivatives, and
(c) converting the amidomethylated bead polymer to an amino-methylated bead polymer.

2. A process according to claim 1 wherein the degree of crosslinking of the monodisperse aminomethylated bead polymer is from 2 to 90%.

3. A process according to claim 1 wherein the average pore diameter of the monodisperse aminomethylated bead polymer is from 100 to 900 Angstrom.

4. A process according to claim 1 wherein the concentration of the functional groups of the monodisperse aminomethylated bead polymer is from 0.2 to 3.0 mol/l.

5. A process according to claim 1 wherein the monodisperse aminomethylated bead polymer is used in the form of a bed.

6. A process according to claim 5 wherein the gases are acidic gases or organic gases or vapors.

7. A process according to claim 6 wherein the acidic gases are CO, CO₂, NO, NO₂, N₂O, N₂O₅, SO₂, SO₃, HCl, HBr, H₂S, HCN, dicyan, or phosgene.

8. A process according to claim 5 wherein the open, closed, or partially closed system or space is a survival system for spacecraft, vehicles, buildings, plants, aircraft, mines, or chemical factories; a respiratory device; a survival system in the medical sector; or diving equipment.

9. A process according to claim 5 wherein the open, closed, or partially closed system or space is a respiratory protection mask, protective clothing, or a survival system.

10. A respiratory protection mask, protective clothing, or a survival system provided with a monodisperse aminomethylated bead polymer in the form of a bed according to claim 5 in an amount sufficient to remove acidic gases or organic gases or vapors over prolonged periods by adsorption.

11. A process for regenerating monodisperse aminomethylated bead polymers that have been saturation with acidic gases or with organic gases or vapors comprising
(1) applying steam under atmospheric conditions, or
(2) applying subatmospheric pressure, with or without additional application of heat and/or of hot gases, or
(3) applying heated or unheated CO₂-free air.
